(19) United States
(12) Patent Application Publication
(10) Pub. No.: US 2002/0173991 A1
(43) Pub. Date: Nov. 21, 2002

(54) Health care information management system and method

(76) Inventor: Boaz Avitall, Chicago, IL (US)

Correspondence Address: Patent Law & Venture Group, 3151 Airway Ave., Suite K-105, Costa Mesa, CA, 92626, US

(21) Appl. No.: 10/150,620

(22) Filed: May 17, 2002

Related U.S. Application Data
(60) Provisional application No. 60/292,118, filed on May 18, 2001.

(51) Int. Cl. G06F 17/60

(52) U.S. Cl. 705/2

(57) ABSTRACT

A health care information management method comprises the steps of establishing point-to-point communication between plural patient monitoring devices, and a distant medical informatics apparatus. Patient health status is continuously, or from time to time, sensed by the patient monitoring devices which establish data signals corresponding to the patient health status. These signals are transferred to the medical informatics apparatus over the data links. The data signals are stored as patient information in a patient information database. A plurality of caregiver monitoring devices are positioned distantly from, and in communication with, at least one of the patient monitoring and the medical informatics apparatus through Internet links and the point-to-point communication links. Patient preset values in the patient information database are compared with patient information and produce an alarm condition when the patient preset values are exceeded.

The present invention claims the priority date of a prior filed provisional patent application having serial No. 60/292,118 and an official filing date of May 18, 2001 and which discloses substantially similar matter as described herein.

### BACKGROUND OF THE INVENTION

1. Field of the Invention

This invention relates generally to health care information systems and more particularly to a distributed health care information system capable identifying a health emergency and providing alarm action to caregivers.

2. Description of Related Art

The following art defines the present state of this field:

U.S. Pat. No. 4,803,625, issued to Fu et al, for example, discloses a portable patient unit connected to a central unit via a telephone line. The portable patient unit includes sensors for weight, temperature, blood pressure and ECG waveforms and may prompt the patient to take medicine, to use the sensors and to supply answers to various questions. The system allows communication between the patient unit and a central station and also can be used to query the patient where discrepancies between measured and expected values exist in the data.

U.S. Pat. No. 4,838,275, issued to Lee, which describes a home medical surveillance system that includes a large number of patient subscriber apparatuses that interface with a central station. Data is taken at a particular predetermined time and transmitted directly to the central station from the patient when taken. Parameters monitored may cover a broad spectrum and include blood pressure, heart rate, ECG, respiration rate and depth, center of gravity shifts, weight, temperature, breathing sounds, shivering, conversational characteristics, average blood glucose and relative cardiac output. The central office or station includes devices for transmitting/receiving interaction between the subscribers and the central station.

Gallant et al, U.S. Pat. No. 5,231,001, describes a microprocessor-based ambulatory patient monitoring system which may use a plurality of devices for measuring such parameters as ECG, blood pressure, oxygen saturation, temperature and respiratory function. Some degree of modularity is contemplated with the monitoring units. Data may be transmitted from the monitoring units over the telephone line to a PC. An optical interface may coordinate operation of one or more of the measuring units. The monitoring units may be coupled to a central computer system also utilized by the physician when particular patient information is relevant to identifying the patient and the data collected is relevant to any particularly measurement protocols, operating parameters and event triggering data.

U.S. Pat. No. 5,012,411, to Policastro et al, further describes a portable microprocessor-controlled apparatus for monitoring, storing and transmitting cardiac, blood pressure and flow, and brain wave data from stored memory to a remote location over a telephone line or to a built-in graphic display or printer.

The prior art teaches the use of telecommunications in the medical field for timely transmission of data but does not teach a system and method for improved management of information. The present invention fulfills these needs and provides further related advantages as described in the following summary.

### SUMMARY OF THE INVENTION

The present invention teaches certain benefits in construction and use which give rise to the objectives described below.

A health care information management method comprises the steps of establishing point-to-point communication between plural patient monitoring devices, and a distant medical informatics apparatus. Patient health status is continuously, or from time to time, sensed by the patient monitoring devices which establish data signals corresponding to the patient health status. These signals are transferred to the medical informatics apparatus over the data links. The data signals are stored as patient information in a patient information database. A plurality of caregiver monitoring devices are positioned distantly from, and in communication with, at least one of the patient monitoring devices and the medical informatics apparatus through Internet links and the point-to-point communication links. Patient preset values in the patient information database are compared with patient information and produce an alarm condition when the patient preset values are exceeded.

A primary objective of the present invention is to provide an apparatus and method of use of such apparatus that provides advantages not taught by the prior art.

Another objective is to provide such an invention capable of timely determination of a health emergency or other situation requiring caregiver action.

A further objective is to provide such an invention capable of alerting caregivers to such a health emergency.

A still further objective is to provide such an invention capable of operation over a large geographical area with dispersed patients and caregivers.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the preferred embodiment of the invention; and

FIG. 2 is information flow diagram thereof.

### DETAILED DESCRIPTION OF THE INVENTION

The above described drawing figures illustrate the invention in at least one of its preferred embodiments, which is further defined in detail in the following description.

The system described in this application provides several unique and innovative designs applied to the remote medical telemanagement of patients with chronic diseases. The Monitoring System is designed to be a global Internet or Intranet based medical informatics system. The system receives and stores physiological data from the patient at home using a Home Health Monitor (HHM) that transmits patient vital signs via a patient telephone line to a server.

Once the patient transmits the data to the server the server automatically transmits the data to a caregiver cell phone, PDA browser as predefined by a server program. The data is communicated via the Internet. The caregiver cell phone is capable of communicating with the Internet since the caregiver communication system is a combination cell phone, internet browser, pager, palm pilot, or any one of these devices, etc. In the case of an alarm or any need to communicate with the patient the caregiver can call directly to the patient phone to talk with the patient.

The unique aspect of this system design is in the system software organization, application, and functionality. The database is divided into institutional and local care centers. The institutional care center may contain local care centers. A care center is a group of patients that are monitored by the system and are divided by location, type of disease, organization membership and provider identity or other factors as may be functional. The institutional care center can monitor all the local care centers, which are linked to it. A provider may have access to only one local care center, or several within an institutional care center. The system administrator is the only person that can assign a provider access to any one of the care centers using a section called provider-carecenter relation. Furthermore each of the institutional care centers has an assigned administrator that is able to create new care centers, archive care centers, and update care center information. The registration of new providers onto the system is also done by either the system or care center administrators.

The HHM and the patients are assigned unique ID numbers. The HHM ID is stored permanently in the HHM read only memory and the patient ID is programmed into the HHM programmable memory. These ID numbers are the key identifiers for the database to recognize which patient is transmitting for the incoming data and remote programming of the HHM by the server using the HHM ID to properly identify the patient's HHM. If the transmitted physiological data exceeds preset values, which are adjusted for each patient, the system flags the patient as having an alarm. The alarmed parameters are sent from the server to the patient caregiver alphanumeric pager along with the patient name, telephone number, the value that caused the alarm, the limits set for triggering an alarm, and the time and date when the patient has taken the measurement. The HHM is a remotely programmable device via the telephone line from the server. Whenever the HHM makes contact with the server the server updates the HHM with regard to updating the clock and any changes to the HHM timing such as daylight saving time, changes in time zone if the patient moves across time zones. The server can turn on and off any physiological parameter in accordance with prescribed settings by the caregiver. In addition the HHM can be remotely programmed to time to remind the patient to take his her measurements at different times, the frequency of data transmission to the server, as for instance, every hour, every 4 hours, every 12 hours, etc.).

Several unique features include the following:

A. Patient management distribution provides a unique means for independent unrelated organizations and providers to see and manage only the patients within their organization despite of the fact that the database contains many other organizations and patients.

B. Management is provided by both local and institutional care centers, whereas the institutional care center can provide monitoring to multiple local care centers and a local care center can provide monitoring to only the patients assigned to that care center.

C. The system design provides for total flexibility of dividing the patient populations as for instance, by locality, caregivers, disease state, organization etc.

D. Security is maintained by restricting access to the data base based on local care center assignment, and system links assignment tailored to each individual provider.

E. The virtual nature of the system.

F. The automatic alarms.

G. The automatic paging and data transfer to mobile communication devices.

H. Remotely fully programmable home health physiological monitoring system as to measurements time and data transmission.

I. Clock synchronization across the globe.

This system is equipped with unique system management tools to allow efficient means of patient, provider, home health monitoring, and system management. The patient management is divided into two parts as follows:

Patient system administration consisting of: adding patients into the system, register a new patient, enter patient information, enter the patient's demographic information select tests and configure parameters. Patient HHM relationship—changing the patient HHM patient demographics, patient archive/unarchive and patient primary physician/nurse relationship patient transfer.

The patient disease management function consisting of: working with patients' information and data transmissions, clearing alarms, the patient management screens notes, setting parameters, remote programming instructions, view add and delete meds, medication list, add medication, view and add allergy, view and add diagnosis, patient narrative medical and social information, patient medical information, patient data download.

The patient disease management allows step-by-step patient registration to include all the patient demographic information, HHM assignment, and caregiver assignment followed by parameters and alarm definition, patient chronic disease conditions allergies and medication. The patient information database includes a comprehensive demographic, medical, laboratory, tests, and social history. A narrative patient medical and social history is also provided and is accessible from every page.

The notes/clear alarm section is unique in several aspects as follows:

A. It provides for clearing one selected alarm with documentation of the alarm clearing patient clinical status.

B. The ability to clear all the outstanding alarms with common clinical notation.

C. Or inserting a note into the patient clinical notation chart without an alarm.

If the note is in response to a physiologic alarm the note is stamped with the Date time of that the alarm was cleared (called intervention date), followed by the note (intervention) author, followed by the date and time that the physiological data that triggered the alarm was taken by the patient, the physiological value, followed by the clinical note. The note is divided into two sections; a preset triage list which includes neurological, cardiac, respiratory, urinary, GI, skin, coagulation, and lastly action taken.

The preselected symptoms are set to the most common symptoms which are encounter in patients monitored with cardiovascular, respiratory, and diabetes diseases. The action taken includes calling 911, re-sent the physiological measurement, change medication, etc. Additional narrative notation space for a note is provided. The caregiver may choose to type a note and not use the triage selection or use both. If several outstanding alarms are being cleared the note is stamped on to every alarm. To accommodate the above note along with 10 others on a single page the space allocation for each note is small and includes a scroller for each note.

The unique features of this patient management software section are:

A. The methods by which the patient and the HHM can be associated and disassociated. Allowing replacement of the HHM with remote programming of the HHM.

B. Patient archiving and un-archiving allowing for patient to be reactivated if the disease state requires re-monitoring.

C. Total flexibility in assignment of caregivers from the providers assigned to the carecenter.

D. Notation and alarm clearing which includes the intervention date, intervention author, the date and time of the alarm, the alarm physiological value followed by the notation.

E. Unique alarm clearing mechanism to allow pre-selected triage for patient symptoms and narrative notation attached to the date, time of the alarm as well as the notation date and the caregiver that is clearing the alarm.

F. The display of multiple notes on a single page with each individual note has a scroller.

Managing care providers includes the following:

Adding Provider information into the system

Provider registration

Change the Provider Demographics

Archiving a Provider

Adding and removing a provider from a care center

Provider System Access

Provider-Care center Assignments (Adding or removing a provider to or from a care center, restricted to administrator)

Features include:

A. A provider cannot be removed from the system unless all the patients assigned to him/her as a primary provider are reassigned to other providers.

B. The ability of any provider to access any of the management links whether related to patient or HHMS, etc. can be restricted or expanded by the institutional or the system administrators.

C. The institutional administrator is restricted to functions related only to the institution he/she is assigned to.

D. Provider can be allowed to access care center if assigned to them by the system administrator.

Managing Home Health Monitors (HHMs)

Adding HHM's into the system

Enter the HHM information into the system Manage HHM's

Editing HHM Information

The HHM usage table

Change the usage of a HHM from “in use” to “free”

Change the usage of a HHM from “free” to “archive”

Change the usage of a HHM from “archive” to “free”

Patient HHM relationship

Moving HHM between care centers View HHM information.

Features include the following:

The HHM management allows for complete tracking of the HHM configuration and the HHM status.

A. The HHM status is defined as HHM in use, free HHM, and HHM archived/in repair. The system maintains a complete record of the HHM assignments to patients, HHM configuration (i.e. what physiological parameters can be monitored) and text entry of comments typed by the administrators regarding the HHM technical operation and any other issues with the HHM.

B. Once an HHM is archived it is removed from the inventory list and not available for patient assignment.

C. The HHM transmission characteristics are set in the HHM management page. These include the stored server telephone number, frequency of transmission of the data.

D. Data transmission from each HHM can be set to occur before at or after preset number of minutes from the each hour or any of the number of time the transmission is programmed to occur (that is once a day at noon, twice, every 6 hours or every hour etc.). The offset is design to minimize the possible collision of multiple servers dialing into the system at the same time causing many to encounter a busy state of the incoming modems. By randomly assigning offset number of minutes the HHMs will likely to encounter open modem thus decreasing the number of modems needed.

E. If the HHM encounter a busy modem it will automatically retry to transmit within 20 second from the first attempt for a total of three times.

F. A complete list of the HHM inventory of the institutional care center, or the system can be obtained and sorted by institution or HHM ID number. The information includes HHM care center assignment, patient name that the HHM is assigned to, free, archived/being fixed.

The disease state management algorithm is based on the most current published and recognized guidelines for the most common chronic disease states, such as congestive heart failure, hypertension, diabetes, asthma etc. The system database includes the patient disease states, allergies, medications (current and past), laboratory data to include renal function, liver function, cardiac function, respiratory function, laboratory tests et c. Along with the patient incoming physiological data the algorithm is able to scrutinize the patient current pharmacological management and provide the caregiver with an assessment of the current management vs. the management algorithm along with the reference of the medical literature. Along with the optimization of the disease management, the system provides the user with medication cost analysis.

Features include the following:

A. Automatic disease state management advisor based on current management algorithm. Optimization of disease state management.

B. Provider feedback and education.

C. Prevention of complications as a result of inappropriate use of drugs (such as drug that the patient is allergic to, drugs that effect renal function, drugs that effect blood pressure if the pressure is too low).

D. Optimization of medication cost.

Patient physical rehabilitation monitored remotely via the HHM. The weight scale as means to monitor patient physical rehabilitation. Using the scale as means to detect feet motion the patient will be asked to walk in place while holding the scale support arms. The strain gages in the scale will be set to detect the feet motion. The number of steps/minute and the length of time the motion was detected will be used to define the exercise level that the patient preformed.

Since the weight scale is an electronic device, the changes in weight that are caused by the patient walking in place on the scale, can be detected and counted by the HHM. The HHM will monitor the total time of exercise along with the rate of exercise. The HHM detects the rate of walking, the total time spent walking. In addition the patient heart rate, ECG, and blood pressure and/or pulse oximetery can be monitored as well during the exercise depending on patient disease and care giver choice. Stress level may be measured as a function of: the average rate of walking X time of walking, BP and HR.

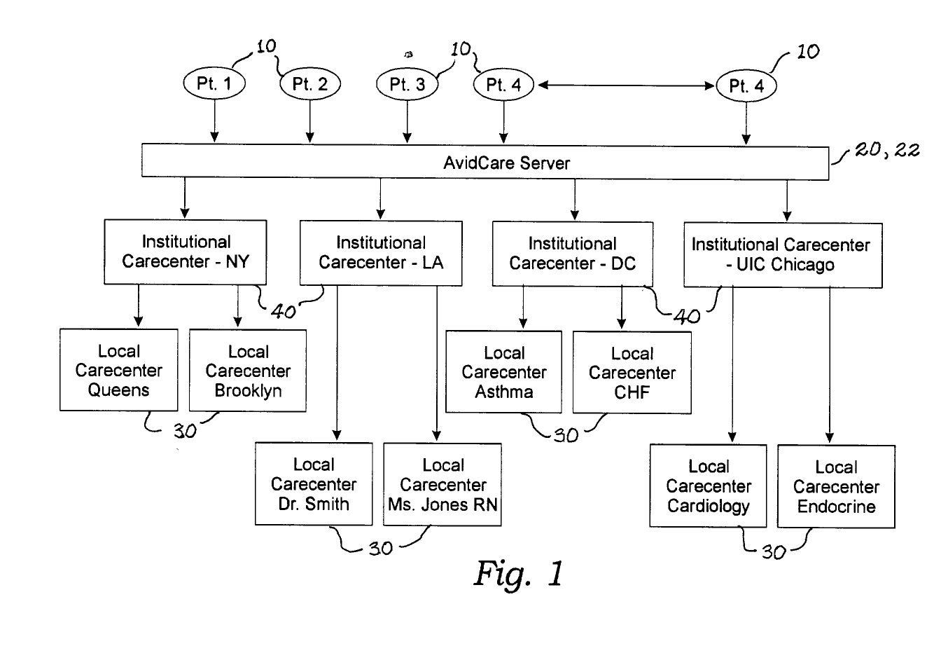

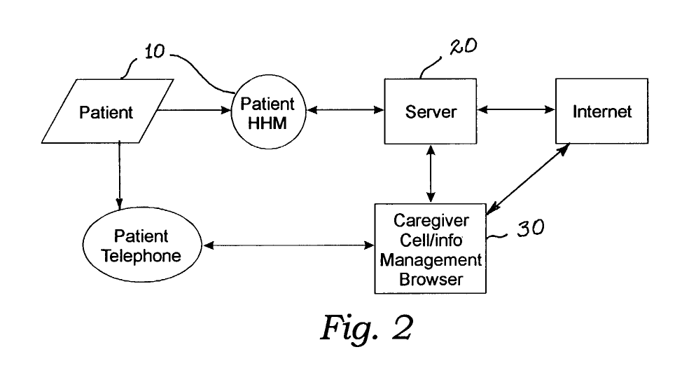

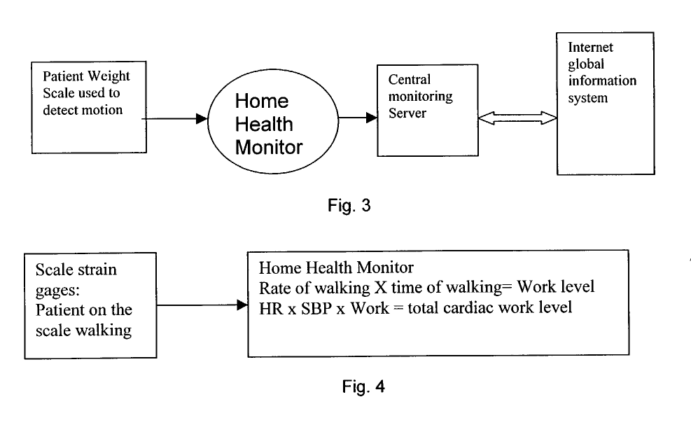

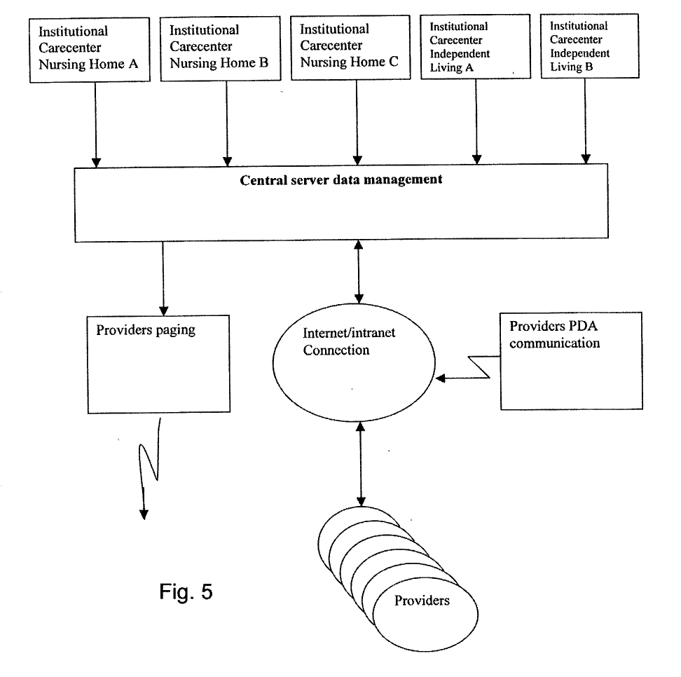

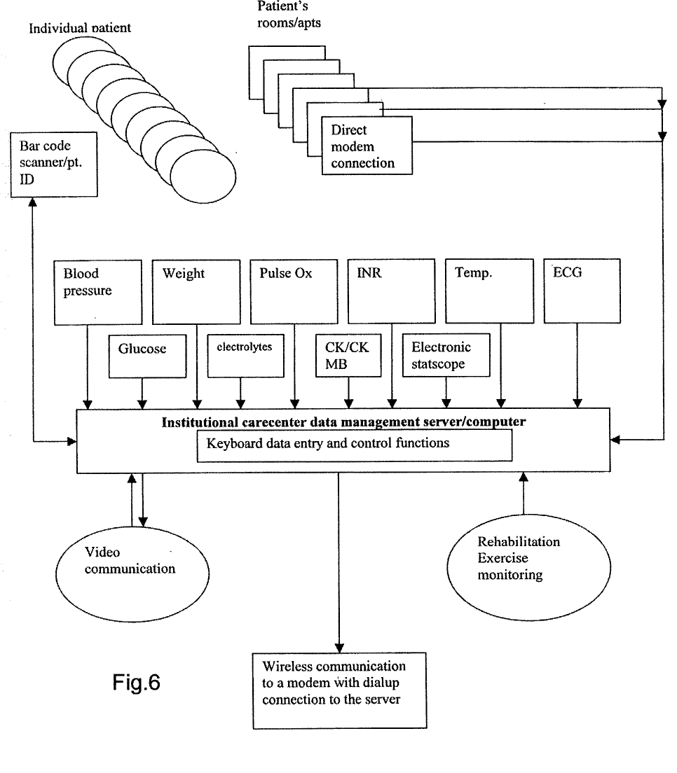

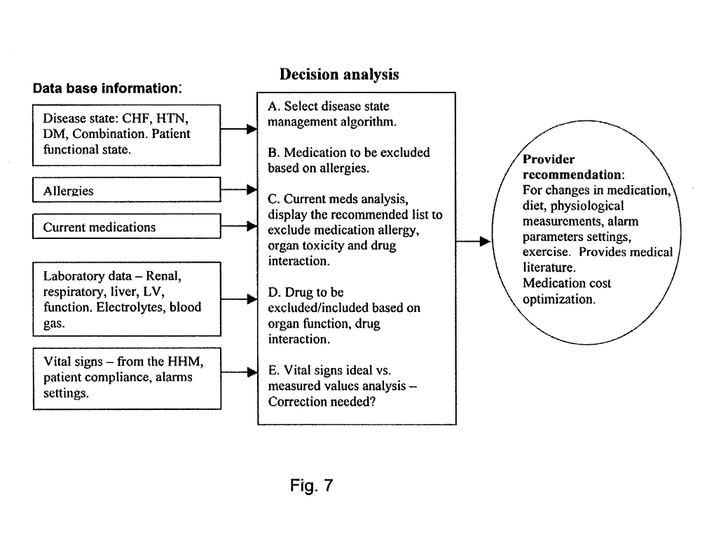

The present invention is a health care information system as shown in FIG. 1, and method of use as defined in FIG. 2. Plural patient monitoring devices 10, identified in FIG. 1, as Pt. 1, 2, 3 and so on, are positioned distantly from, but joined with, a medical informatics apparatus 20, identified in FIG. 1 as “Server” through point-to-point communication links such as is provided by one of the public access telephone networks, i.e., common telephone. The patient monitoring devices 10 are each located at a patient's site, typically their home, and are enabled for sensing patient health status through the use of well known sensors for taking heart rate readings, blood pressure readings and the like. They are further enabled for establishing data signals corresponding to the sensory readings as is also well known in the art. The communication links are enabled for transferring these data signals to the medical informatics apparatus 20 over these telephone networks using a modem or other common data transfer means. The medical informatics apparatus 20 is enabled for storing these data signals as patient information in a patient information database 22 as is well known in the art. A plurality of caregiver monitoring devices 30 are each located distantly from, and in communication with, at least one of the patient monitor devices 10 and the medical informatics apparatus 20 through Internet links and the point-to-point communication links. The patient information database 22 stores patient preset limit values defining normal status for each of the health parameters that are monitored. The medical informatics apparatus 20 is enabled, through standard and well known electronic comparitor circuits, for comparing each patient information received with the corresponding patient preset limit values and for producing an alarm condition, such as an audio or visual output, when said patient preset limit values are exceeded. The medical informatics apparatus 20 is enabled for remotely programming the patient monitoring devices 10 and the patient monitoring devices are enabled for reminding a patient of required actions, such as taking medications or health readings or the like. This is accomplished through common circuits and software programming as would be known to one of skill in the art. The medical informatics apparatus 20 is enabled for providing medical management of the plural patient monitoring devices 10 by the plural caregivers through their caregiver monitoring devices 30. The database 22 is enabled for being accessed by at least one of the following status attributes: patient location, caregiver identity, health state, health organization. Other attribute access categories can be substituted or added to this list, so that it should not be considered as exhaustive. The database 22 is enabled, through a coding or personal identification number (PIN) for restricting access to unauthorized personnel and it is also enabled for auto-paging a corresponding caregiver when an alarm condition for a corresponding patent is produced.

In a general case of the above embodiment, a central medical informatics apparatus 40 is in communication with a plurality of the medical informatics apparatus 30 and may further be in communication with some of the patient monitoring devices and the caregiver monitoring devices. In this embodiment, the central medical informatics apparatus 40 is enabled for global clock synchronization.

In a further embodiment of the invention the system described above provides a method of operation including establishing point-to-point communication between each one of the plural patient monitoring devices 10, and the medical informatics apparatus 20; sensing patient health status with the patient monitoring devices 10; establishing data signals corresponding to patient health status; transferring the data signals to the medical informatics apparatus 20 over the data links; storing the data signals as patient information in a patient information database 22; providing a plurality of caregiver monitoring devices 30 each positioned distantly from, and in communication with, at least one of the patient monitoring devices 10 and the medical informatics apparatus 20 through Internet links and/or the point-to-point communication links; providing patient preset limit values in the patient information database 22; comparing each patient information with the corresponding patient preset limit values; and producing an alarm condition when at least one of the patient preset values is exceeded.

The method may further comprise the steps of remotely programming the patient monitoring devices 10; reminding a patient of required actions from the medical informatics apparatus 20; providing medical management of the plural patient monitoring devices 10 by the plural caregivers 30; enabling the database for being accessed by at least one categorical state such as: patient location, caregiver identity, health state, health organization; restricting access to the database to authorized personnel only; and autopaging a corresponding caregiver when at least one alarm condition is produced.

In a further embodiment of the preceding method a central medical informatics apparatus 40 is enabled for communication with the plurality of medical informatics apparatus 30 and further enabled for communication with at least one of the patient monitoring devices 10 and at least one of the caregiver monitoring devices 20. The central medical informatics system 40 provides the further step of establishing global clock synchronization

Patient physical activity monitoring and rehabilitation using the scale as an activity sensor and monitoring the effect of this physical activity on the physiological parameters. Disease state management algorithms and drug management capability.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A health care information system comprising: plural patient monitoring devices, each positioned distantly from, and joined with, at least one medical informatics apparatus through communication links; the patient monitoring devices enabled for sensing patient health status and further enabled for establishing data signals corresponding thereto; the communication links enabled for transferring the data signals to the at least one medical informatics apparatus; the at least one medical informatics apparatus enabled for storing the data signals as patient information in a patient information database; a plurality of caregiver monitoring devices each positioned distantly from, and in communication with, at least one of the patient monitoring devices and the at least one medical informatics apparatus through the communication links; the patient information database providing patient preset values; the at least one medical informatics apparatus enabled for comparing each patient information in the patient information database, with the corresponding patient preset values and for producing an alarm condition when said patient preset values are exceeded.

2. The system of claim 1 wherein the medical informatics apparatus is enabled for remotely programming the patient monitoring devices.

3. The system of claim 1 wherein the patient monitoring devices are enabled for reminding a patient of required actions.

4. The system of claim 1 wherein the medical informatics apparatus is enabled for providing medical management of the plural patient monitoring devices by the plural caregivers.

5. The system of claim 1 wherein the database is enabled for being accessed by at least one of: patient location, caregiver identity, health state, health organization.

6. The system of claim 1 wherein the database is enabled for restricting access to unauthorized persons.

7. The system of claim 1 further enabled for autopaging a corresponding caregiver when said alarm condition is produced.

8. A health care information management method comprising the steps of: establishing communication between plural patient monitoring devices, and at least one medical informatics apparatus; enabling the patient monitoring devices for sensing patient health status and for establishing data signals corresponding thereto; enabling communication links for transferring the data signals to one of the medical informatics apparatus; storing the data signals in the one medical informatics apparatus as patient information in a patient information database; providing plural caregiver monitoring devices, each positioned distantly from, and in communication with, at least one of the patient monitoring devices and with the at least one medical informatics apparatus; providing the patient information database with patient preset values; enabling the at least one medical informatics apparatus for comparing the patient information with the patient preset values and for producing an alarm condition when the patient preset values are exceeded; and providing a central medical informatics apparatus enabled for communication with the plurality of medical informatics apparatus and further enabled for communication with at least one of the patient monitoring devices and at least one of the caregiver monitoring devices.

9. The system of claim 8 further enabled for global clock synchronization.

10. A health care information management method comprising the steps of: establishing communication between plural patient monitoring devices, and a medical informatics apparatus; sensing patient health status with the patient monitoring devices; establishing data signals corresponding to the patient health status; transferring the data signals to the medical informatics apparatus over data links; storing the data signals as patient information in a patient information database; providing a plurality of caregiver monitoring devices each positioned distantly from, and in communication with the medical informatics apparatus through communication links; providing patient preset values in the patient information database; comparing each patient information with the corresponding patient preset values; and producing an alarm condition when said patient preset values are exceeded.

11. The method of claim 10 further comprising the step of remotely programming the patient monitoring devices.

12. The method of claim 10 further comprising the step of reminding a patient of required actions from the medical informatics apparatus.

13. The method of claim 10 further comprising the step of providing medical management of the plural patient monitoring devices by the plural caregivers.

14. The method of claim 10 further comprising the step of enabling the database for being accessed by at least one of: patient location, caregiver identity, health state, health organization.

15. The method of claim 10 further comprising the step of restricting access to the database to authorized personnel.

16. The method of claim 10 further comprising the step of autopaging a corresponding caregiver when said alarm condition is produced.

17. A health care information management method comprising the steps of: establishing communication between each of plural patient monitoring devices, and at least one of a plurality of medical informatics apparatus through communication links; sensing a patient health status with each of the patient monitoring devices; establishing data signals corresponding thereto; transferring the data signals to the respective medical informatics apparatus; storing each of the data signals as patient information in a patient information database; providing plural caregiver monitoring devices in communication with, at least one of the patient monitoring devices and with the respective medical informatics apparatus through Internet links and through the communication links; providing patient preset values within each said patient information database; comparing the patient information with the patient preset values; producing an alarm condition when the patient preset values are exceeded; and providing a central medical informatics apparatus enabled for communication with the plurality of medical informatics apparatus and further enabled for communication with at least one of the patient monitoring devices and at least one of the caregiver monitoring devices for accumulating all of the patient information in a single database.

18. The method of claim 17 further comprising the step of establishing global clock synchronization.

19. The system of claim 1 further comprising a means for monitoring patient physical activity using a weight scale with a strain gauge device enabled for sensing a patient walking in place while on the weight scale, and further enabled for producing the data signals as patient information including the rate and the time of day, blood pressure, heart rate and oxigenation as associated with the walking in place.
